(19) United States
(12) Patent Application Publication
(10) Pub. No.: US 2026/0045076 A1
(43) Pub. Date: Feb. 12, 2026

(54) DRIVING SCENARIO-BASED MODIFICATIONS FOR VEHICLE PERCEPTION SYSTEMS

(71) Applicant: TOYOTA MOTOR ENGINEERING & MANUFACTURING NORTH AMERICA, INC., PLANO, TX (US)

(72) Inventors: YONGKANG LIU, Mountain View, CA (US); XIAOFEI CAO, Mountain View, CA (US); EMRAH AKIN SISBOT, Mountain View, CA (US); YASHAR ZEIYNALI FARID, Mountain View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 18/795,736

(22) Filed: Aug. 6, 2024

(51) Int. Cl. G06V 10/82; G06T 3/4046; G06V 10/25; G06V 20/58

(52) U.S. Cl. CPC G06V 10/82; G06T 3/4046; G06V 10/25; G06V 20/586

(57) ABSTRACT

Embodiments provide systems and methods that tailor, based on driving scenario for a vehicle: (1) operation of a neural network (used to process image data obtained during the driving scenario) to skip a determined number of neural layers; and (2) input scale for image data provided to the neural network. In this way, systems and methods can scale computational power and efficiency for image processing tasks as needed based on the nature and relative complexity of different driving scenarios.

### TECHNICAL FIELD

The present disclosure relates generally to automotive systems and technologies. More particularly, some embodiments relate to driving scenario-based modifications for vehicle perception systems.

### DESCRIPTION OF RELATED ART

A neural network (sometimes referred to as an artificial neural network) is a type of machine-learning model inspired by structure of the human brain. For example, a neural network may comprise interconnected (artificial) “neurons” arranged into neural layers (much like in a human brain). A respective neuron may implement an activation function (e.g., an algorithm) that computes an output based on weighted inputs the respective neuron receives from one or more neurons in a previous neural layer.

Spatial perception generally refers to the ability to perceive and understand spatial relationships between objects, people, and the environment. In automotive applications (e.g., autonomous driving), spatial perception involves a vehicle's ability to perceive and understand its surroundings in a three-dimensional (3D) space. Accordingly, so called “vehicle perception systems” often rely on a combination of sensors, such as cameras, LiDAR (Light Detection and Ranging), radar, and GPS, to gather information about a vehicle's surrounding environment. By analyzing the data obtained from such sensors, a vehicle perception system can create a refined representation of a vehicle's surrounding environment, including other vehicles, pedestrians, road signs, obstacles, etc. The vehicle may then use the refined representation for various tasks related to autonomous driving or navigation, such as object detection, map segmentation, etc.

### BRIEF SUMMARY OF THE DISCLOSURE

According to various embodiments of the disclosed technology, a method is provided. The method may comprise: (1) determining a driving scenario for a vehicle; (2) modifying operation of a neural network to skip a determined number of neural layers based on the driving scenario; and (3) using the neural network with the modified operation to process image data obtained by the vehicle during the driving scenario.

In certain embodiments of the method, modifying operation of the neural network to skip the determined number of neural layers may comprise at least one of: (a) activating one or more skip connections in the neural network; or (b) deactivating one or more skip connections in the neural network.

In some embodiments of the method, modifying operation of the neural network to skip the determined number of neural layers may comprise maintaining trained weights of the neural network constant.

In various embodiments of the method, the method may further comprise: (1) determining a second driving scenario for the vehicle; (2) second modifying operation of the neural network to skip a second determined number of neural layers based on the second driving scenario; and (3) using the neural network with the second modified operation to process image data obtained by the vehicle during the second driving scenario. Here, the determined number may comprise a number of zero or greater, and the second determined number may be greater than the determined number. In some of such embodiments, the driving scenario may be a parking scenario and the second driving scenario may be a city driving scenario or a highway driving scenario. In other of such embodiments, the first driving scenario may be a city driving scenario and the second driving scenario may be a highway driving scenario.

In various embodiments, a second method is provided. The second method may comprise: (1) determining a driving scenario for a vehicle; (2) based on the driving scenario, modifying input scale for image data obtained by the vehicle during the driving scenario; and (3) using a neural network to process the modified image data.

In certain embodiments of the second method, modifying the input scale for the image data may comprise at least one of: (a) modifying spatial input scale for the image data based on the driving scenario; or (b) modifying temporal input scale for the image data based on the driving scenario. In some embodiments of such embodiments, modifying the spatial input scale for the image data may comprise modifying image resolution for the image data based on the driving scenario. Likewise, modifying the temporal input scale for the image data may comprise modifying frame rate for the image data based on the driving scenario.

In some embodiments of the second method, the second method may further comprise: (1) determining a second driving scenario for the vehicle; (2) based on the second driving scenario, modifying input scale for second image data obtained by the vehicle during the second driving scenario; and (3) using the neural network to process the modified second image data. Here, modifying the input scale for the image data may comprise at least one of: (a) modifying the image data to a first image resolution based on the driving scenario; or (b) modifying the image data to a first frame rate based on the driving scenario. Likewise, modifying the input scale for the second image data may comprise at least one of: (a) modifying the second image data to a second image resolution based on the second driving scenario; or (b) modifying the second image data to a second frame rate based on the second driving scenario. The first image resolution may comprise a greater number of pixels per unit area than the second image resolution. Similarly, the first frame rate may comprise a greater number of frames per unit time than the second frame rate. In some of such embodiments, the driving scenario may be a parking scenario and the second driving scenario may be a city driving scenario or a highway driving scenario. In other of such embodiments, the driving scenario may be a city driving scenario and the second driving scenario is a highway driving scenario.

In various embodiments of the second method, the second method may further comprise modifying input size for the image data based on the driving scenario. Here, the modified image data may comprise the input scale modification and the input size modification. In some of such embodiments, modifying the input size for the image data may comprise at least one of: (a) modifying a spatial input size for the image data based on the driving scenario; or (b) modifying a temporal input size for the image data based on the driving scenario. Here, modifying the spatial input size for the image data may comprise modifying a spatial region of interest size for the image data based on the driving scenario and modifying the temporal input size for the image data may comprise modifying a time duration for the image data based on the driving scenario.

In some embodiments a third method is provided. The third method may comprise: (1) responsive to determining a first driving scenario for a vehicle: (a) modifying first image data obtained by the vehicle during the first driving scenario to a first input scale and a first input size; and (b) using a neural network to process the modified first image data; and (2) responsive to determining a second driving scenario for a vehicle: (a) modifying second image data obtained by the vehicle during the second driving scenario to a second input scale and a second input size; and (b) using a neural network to process the modified second image data. Here, the first input scale may comprise a finer input scale than the second input scale. Relatedly, the first input size may comprise a smaller input size than the second input size.

In certain embodiments of the third method, modifying the first image data to the first input scale may comprise at least one of: (a) modifying the first image data to a first image resolution; or (b) modifying the first image data to a first frame rate. Relatedly, modifying the first image data to the first input size may comprise at least one of: (a) modifying the first image data to a first spatial region of interest size; or (b) modifying the first image data to a first time duration. Likewise, modifying the second image data to the second input scale may comprise at least one of: (a) modifying the second image data to a second image resolution, wherein the first image resolution comprises a greater number of pixels per unit area than the second image resolution; or (b) modifying the second image data to a second frame rate, wherein the first frame rate comprises a greater number of frames per unit area than the second frame rate. Likewise, modifying the second image data to the second input size may comprise at least one of: (a) modifying the second image data to a second spatial region of interest size, wherein the first spatial region of interest is smaller than the second spatial region of interest; or (b) modifying the second image data to a second time duration, wherein the first time duration is shorter than the second time duration.

In some embodiments, a vehicle is provided. The vehicle may comprise: (1) one or more processing resources; and (2) non-transitory computer-readable medium, coupled to the one or more processing resources, comprising stored instructions that when executed by the one or more processing resources, cause the vehicle to: (a) responsive to determining a first driving scenario for the vehicle: (i) modify operation of a neural network to skip a first determined number of neural layers based on the first driving scenario; (ii) modify first image data obtained by the vehicle during the first driving scenario to a first input scale; and (iii) use the neural network the modified operation to process the modified first image data; and (b) responsive to determining a second driving scenario for the vehicle: (i) second modify operation of the neural network to skip a second determined number of neural layers based on the second driving scenario, wherein the second determined number of neural layers is greater than the first determined number of neural layers; (ii) modify second image data obtained by the vehicle during the second driving scenario to a second input scale, wherein the second input scale comprises a coarser input scale than the first input scale; and (iii) use the neural network with the second modified operation to process the modified second image data.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example vehicle, in accordance with various embodiments of the presently disclosed technology.

FIGS. 2A-2C illustrate an example process that can be performed by a vehicle to tailor a number of skipped neural layers for a neural network based on driving scenario, in accordance with various embodiments of the presently disclosed technology

FIGS. 3A-3C illustrate an example process that can be performed by a vehicle to dynamically modify an input scale/input size for image data provided to a neural network based on driving scenario, in accordance with various embodiments of the presently disclosed technology.

FIG. 4 illustrates an example process for processing image data obtained by a vehicle, in accordance with various embodiments of the presently disclosed technology.

FIG. 5 illustrates another example process for processing image data obtained by a vehicle, in accordance with various embodiments of the presently disclosed technology.

FIG. 6 illustrates an example process that can be performed to tailor a number of skipped neural layers for a neural network based on driving scenario, in accordance with various embodiments of the presently disclosed technology.

FIG. 7 illustrates an example process that can be performed to dynamically modify an input scale/input size for image data provided to a neural network based on driving scenario, in accordance with various embodiments of the presently disclosed technology.

FIG. 8 is an example computing component that may be used to implement various features of embodiments described in the present disclosure.

The figures are not exhaustive and do not limit the present disclosure to the precise form disclosed.

### DETAILED DESCRIPTION

Many conventional vehicle perception systems rely on neural networks for various tasks.

For example, a vehicle perception system may obtain image data (e.g., a stream of images) of an environment surrounding a vehicle from one or more vehicle sensors (e.g., one or more cameras mounted on the vehicle). The vehicle perception system may use a neural network to extract critical features of the image data (such a neural network which specializes in feature extraction is sometimes referred to as a backbone neural network). The vehicle perception system may then use an encoder (which may comprise another neural network) to generate a refined representation of the environment based on the extracted features. The vehicle may then use the refined representation for various tasks related to autonomous driving or navigation, such as object detection, map segmentation, etc. The autonomous driving/navigation tasks may also be facilitated by neural networks/machine learning.

Computational power for the vehicle perception-related tasks described above may be increased with increasing neural network depth (i.e., an increasing number of neural layers). However, increased neural network depth (and corresponding increased computational power) will generally come at a cost of increased processing time and increased power consumption.

In certain cases, accuracy/reliability for the vehicle perception-related tasks described above may be improved by using a finer input scale for image data provided to a neural network. For example, providing a backbone neural network with higher resolution image data (i.e., image data represented using a greater number of pixels per unit area) can improve accuracy/reliability for a feature extraction task. However, utilizing finer input scale image data will also generally come at a cost of increased processing time and increased power consumption.

Against this backdrop, aspects of the presently disclosed technology may be implemented to provide systems and methods which dynamically modify at least one of the following based on driving scenario: (1) operation of a neural network to skip a determined number of neural layers of the neural network; or (2) input scale for image data provided to the neural network.

By tailoring a number of skipped neural layers to different driving scenarios, systems and methods can increase computational power (i.e., by skipping a relatively fewer number of neural layers) as complexity for the different driving scenarios increases. In this way, systems and methods may perform more accurately/reliably during relatively more complex driving scenarios than alternative solutions. Relatedly, systems and methods can decrease computational power (i.e., by skipping a relatively greater number of neural layers and thus performing relatively fewer matrix computations) as complexity for the different driving scenarios decreases. In this way, systems and methods may perform faster and consume less power during relatively less complex driving scenarios than alternative solutions.

By tailoring input scale for image data to different driving scenarios, systems and methods can leverage finer input scales (e.g., a relatively greater number of pixels per unit area, a relatively greater number of frames per unit time, etc.) as complexity for the different driving scenarios increases. In this way, systems and methods may perform more accurately/reliably during relatively more complex driving scenarios than alternative solutions. Relatedly, systems and methods can leverage coarser input scales (e.g., a relatively smaller number of pixels per unit area, a relatively smaller number of frames per unit time, etc.) as complexity for the different driving scenarios decreases. In this way, systems and methods may perform faster and consume less power during relatively less complex driving scenarios than alternative solutions.

In certain implementations, systems and methods may also tailor input size based on driving scenario. For example, systems and methods can leverage relatively larger input sizes (e.g., relatively larger spatial regions of interest for image data, relatively larger time durations for image data) for driving scenarios which involve relatively larger spatial and temporal focuses (e.g., highway driving scenarios). By contrast, systems and methods can leverage relatively smaller input sizes (e.g., relatively smaller spatial regions of interest for image data, relatively shorter time durations for image data) for driving scenarios which involve relatively smaller spatial and temporal focuses (e.g., parking scenarios). By tailoring the input size of image data provided to a neural network based on driving scenario, systems and methods may perform more accurately/reliably and consume less power than alternative solutions.

As should be appreciated, the above-described tailoring (and resultant advantages) may be realized in conjunction with just a single neural network. Moreover, the above-described tailoring (and resultant advantages) may be realized without adjusting trained weights (or other parameters) of the single neural network. For example, modifying operation of the single neural network to skip a determined number of neural layers will not generally modify, or otherwise depend on, values of trained weights of the single neural network. Likewise, modifying input scale/input size of image data provided to the single neural network will not generally modify, or otherwise depend on, values of trained weights of the single neural network.

Because the above-described tailoring (and resultant advantages) may be realized in conjunction with a single unmodified neural network, systems and methods may consume significantly less memory than potential alternative solutions that—e.g., utilize multiple neural networks trained for different driving scenarios, or modify trained weights of a neural network based on driving scenario. Namely, systems and methods may simply store and access trained weights of a single unmodified neural network for many different driving scenarios. By contrast, potential alternative solutions may need to store and access trained weights associated with multiple neural networks, or multiple neural network modifications. As typical neural networks can have upwards of a billion weights—which consume significant memory and processing resources to store and access—the savings realized using a single unmodified neural network for many different driving scenarios can be significant.

The systems and methods disclosed herein may be implemented with any of a number of different vehicles and vehicle types. For example, the systems and methods disclosed herein may be used with automobiles, trucks, motorcycles, recreational vehicles and other types of vehicles. In addition, the principles disclosed herein may be utilized by systems that are external from vehicles.

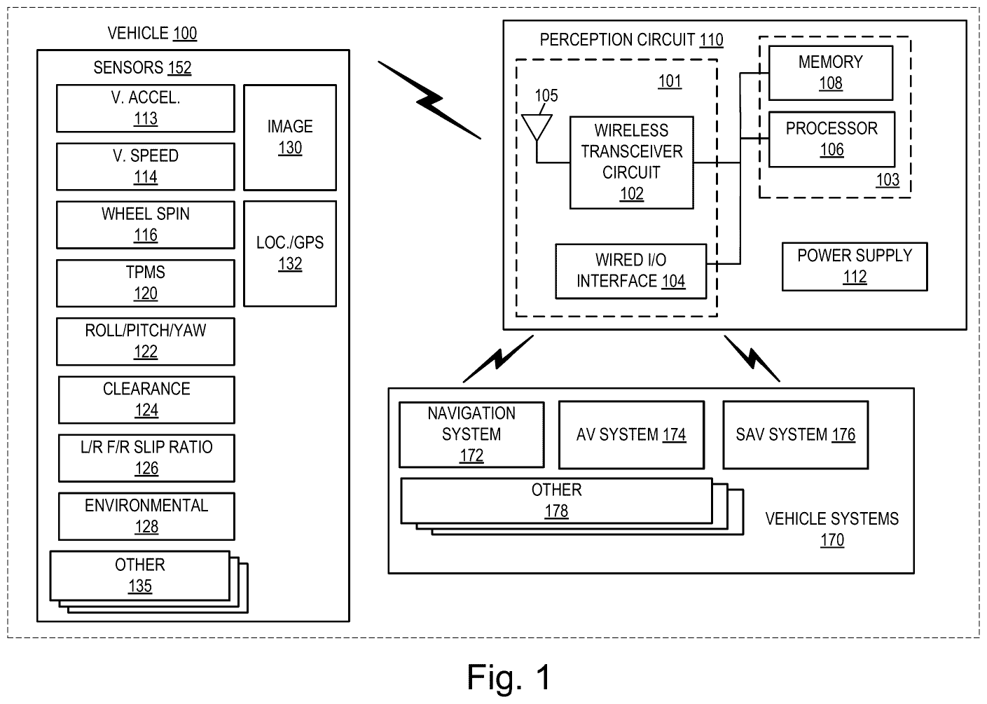

FIG. 1 illustrates an example vehicle 100, in accordance with various embodiments of the presently disclosed technology.

Before describing individual components of vehicle 100 in more detail, a high level operational overview may be useful.

In certain implementations, perception circuit 110 can obtain data related to operational parameters of vehicle 100 and parameters related to vehicle 100's contextual environment from sensors 152 and vehicle systems 170. Based on such operational and contextual environment parameters, perception circuit 110 can determine a driving scenario that vehicle 100 is currently operating in. Then, based on the determined driving scenario, perception circuit 110 can modify at least one of: (1) operation of a neural network (used to process image data obtained by vehicle 100 during the determined driving scenario) to skip a determined number of neural layers; or (2) input scale and input size for the image data before the image data is provided to the neural network. After perception circuit 110 has utilized the neural network (with the modified operation) to process the image data comprising the modified input scale/modified input size, perception circuit 110 can utilize the processed image data to generate a refined representation of the environment surrounding vehicle 100. Vehicle 100 may then use the refined representation of the environment for various tasks related to autonomous driving or navigation, such as object detection, map segmentation, etc. The autonomous driving/navigation tasks may also be facilitated by neural networks/machine learning.

In this way, perception circuit 110 may perform more reliably/accurately during relatively more complex driving scenarios than conventional/alternative vehicle perception systems. Relatedly, perception circuit 110 may perform faster and consume less power during relatively less complex driving scenarios than conventional/alternative vehicle perception systems.

Referring now to vehicle 100 and FIG. 1 in more detail, as depicted, vehicle 100 comprises a perception circuit 110, sensors 152, and vehicle systems 170. Sensors 152 and vehicle systems 170 can communicate with perception circuit 110 via a wired or wireless communication interface. Although sensors 152 and vehicle systems 170 are depicted as communicating with perception circuit 110, they can also communicate with each other. Perception circuit 110 can be implemented as an electronic control unit (ECU) or as part of an ECU. In other embodiments, perception circuit 110 can be implemented independently of an ECU.

In the specific example of FIG. 1, perception circuit 110 includes a communication circuit 101, a decision circuit 103 (including a processor 106 and a memory 108), and a power supply 112. Components of perception circuit 110 are illustrated as communicating with each other via a data bus, although other interfaces can be included.

Processor 106 can include one or more general processing units (GPUs), central processing units (CPUs), microprocessors, or any other suitable processing system. Processor 106 may include a single core processor or multicore processors. Memory 108 may include one or more various forms of memory or data storage (e.g., flash, RAM, etc.) that may be used to store trained weights and other parameters of neural networks, instructions and variables for processor 106, as well as any other suitable information. Memory 108 can be made up of one or more modules of one or more different types of memory, and may be configured to store data and other information as well as operational instructions that may be used by processor 106.

Although the example of FIG. 1 is illustrated using processor and memory circuitry, in various embodiments decision circuit 103 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up perception circuit 110.

Communication circuit 101 can utilize a wireless transceiver circuit 102 with an associated antenna 105 for wireless communication. Communication circuit 101 can also utilize a wired I/O interface 104 with an associated hardwired data port (not illustrated). As this example illustrates, communications with perception circuit 110 can include either or both wired and wireless communications. Wireless transceiver circuit 102 can include a transmitter and a receiver (not shown) to allow wireless communications via any of a number of communication protocols such as, for example, Wifi, Bluetooth, near field communications (NFC), Zigbee, and any of a number of other wireless communication protocols whether standardized, proprietary, open, point-to-point, networked or otherwise. Antenna 105 is coupled to wireless transceiver circuit 102 and is used by wireless transceiver circuit 102 to transmit radio signals wirelessly to wireless equipment and to receive radio signals as well. These radio signals can include information of almost any sort that is sent or received by perception circuit 110 to/from other entities such as sensors 152, vehicle systems 170, other connected vehicles, connected roadside infrastructure, cloud computing entities, etc.

Wired I/O interface 104 can include a transmitter and a receiver (not shown) for hardwired communications with other devices. For example, wired I/O interface 104 can provide a hardwired interface to other components, including sensors 152 and vehicle systems 170. Wired I/O interface 104 can communicate with other devices using Ethernet or any of a number of other wired communication protocols whether standardized, proprietary, open, point-to-point, networked or otherwise.

Power supply 112 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 152 can include, for example, vehicle acceleration sensors 113, vehicle speed sensors 114, wheelspin sensors 116 (e.g., one for each wheel), a tire pressure monitoring system (TPMS) 120, accelerometers such as a 3-axis accelerometer 122 to detect roll, pitch and yaw of the vehicle, vehicle clearance sensors 124, left-right and front-rear slip ratio sensors 126, environmental sensors 128 (e.g., to detect salinity or other environmental conditions), image sensor(s) 130, and location sensor(s) 132. Other sensors 135 can also be included as may be appropriate for a given implementation of vehicle 100. For example, other sensors 135 may include gyroscopes, odometers, etc.

In some embodiments, image sensor(s) 130 may comprise one or more cameras configured to obtain image data of an environment surrounding vehicle 100. In certain implementations where image sensor(s) 130 comprise multiple cameras, the multiple cameras may be mounted at multiple locations on vehicle 100. Accordingly, the multiple cameras may obtain image data comprising multiple perspectives (i.e., from the different mounting locations on vehicle 100) of the environment surrounding vehicle 100. In some implementations, image sensor(s) 130 may obtain a stream of images, akin to a video stream.

In certain embodiments, location sensor(s) 132 may comprise a global navigation satellite sensor, a global position sensor, or other types of vehicle positioning sensors. Location sensor(s) 132 may be configured to generate location data for vehicle 100 and/or location data for landmarks in the environment surrounding vehicle 100. The location data may comprise precise coordinates (e.g., latitude, longitude, and altitude) of vehicle 100's position or the position(s) of landmark(s) on the Earth's surface.

In some embodiments, one or more of sensors 152 may include their own processing capability to compute the results for additional information that can be provided to perception circuit 110. In other embodiments, one or more of sensors 152 may be data-gathering-only sensors that only provide raw data to perception circuit 110. In further embodiments, one or more hybrid sensors may be included that provide a combination of raw data and processed data to perception circuit 110. Sensors 152 may provide analog outputs, digital outputs, or a combination of both.

Vehicle systems 170 can include any of a number of different vehicle components or subsystems used to control or monitor various aspects of vehicle 100 and its performance. For example, vehicle systems 170 may include any one or combination of a navigation system 172, an autonomous vehicle (AV) system 174, a semi-autonomous vehicle (SAV) system 176, and other vehicle systems 178.

AV system 174 and SAV system 176 can control driving behaviors of vehicle 100. For example, AV system 174 and SAV system 176 can interpret sensory information, identify appropriate traffic configurations, determine vehicle navigation paths, and actuate vehicle systems in accordance with determined vehicle navigation paths.

As alluded to above, AV system 174 and SAV system 176 can leverage refined representations of vehicle 100's environment generated by perception circuit 110 to determine vehicle navigation paths. In general, improved accuracy/reliability and faster availability for the refined representation can result in improved decision making for an AV/SAV system leveraging the refined representations. Accordingly, AV system 174 and SAV system 176 can leverage rapidly generated and accurate/reliable refined representations—generated by perception circuit 110—for improved autonomous/semi-autonomous driving performance. Relatedly, navigation system 172 can leverage such refined representations for improved navigation displays.

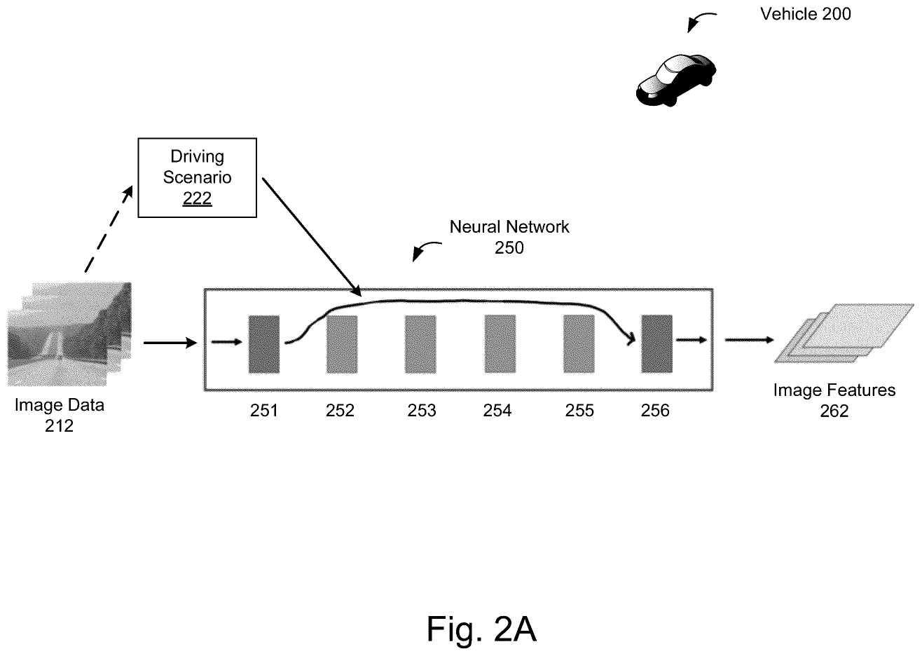

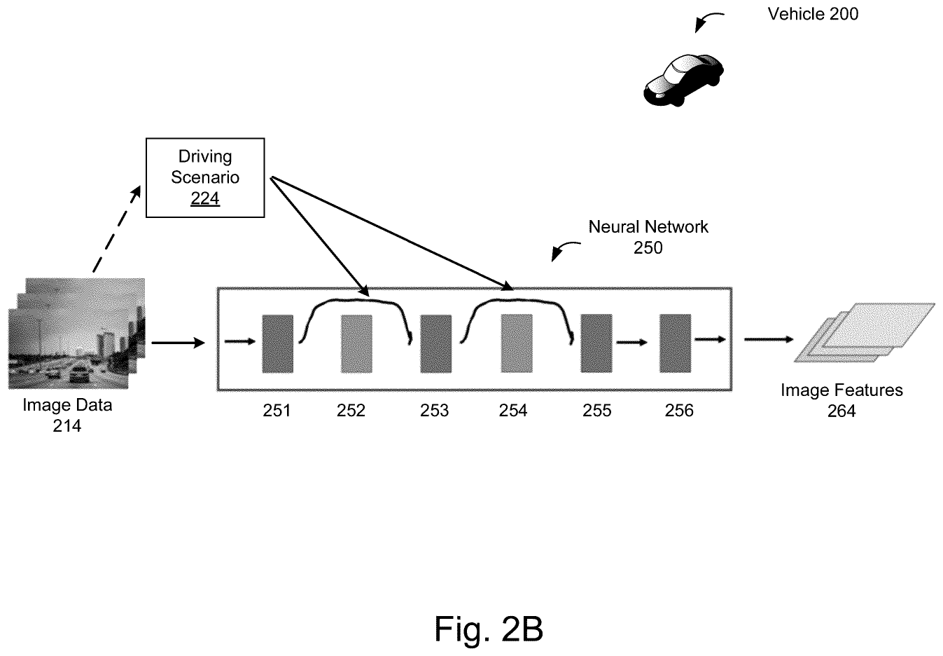

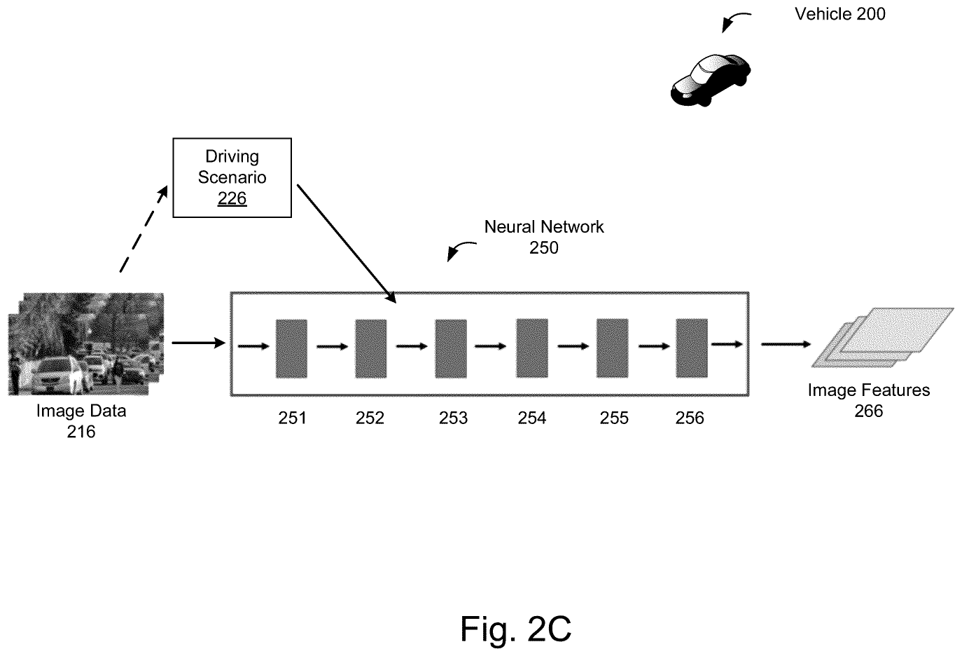

FIGS. 2A-2C illustrate an example process that may be performed by a vehicle 200 to tailor a number of skipped neural layers for a neural network 250 based on a driving scenario, in accordance with various embodiments of the presently disclosed technology. In certain implementations, vehicle 200 may be the same/similar vehicle as vehicle 100 described in conjunction with FIG. 1

As depicted in FIGS. 2A-2C, vehicle 200 may determine different driving scenarios that it is operating in. For example, in FIG. 2A vehicle 200 determines that it is operating in a (first) driving scenario 222. In FIG. 2B, vehicle 200 determines that it is operating in a (second) driving scenario 224. In FIG. 2C, vehicle 200 determines that it is operating in a (third) driving scenario 226.

Vehicle 200 may utilize various techniques to make these driving scenario determinations.

For example, in certain implementations, each of driving scenarios 222, 224, and 226 may comprise one of multiple pre-defined driving scenarios (e.g., a highway driving scenario, a city driving scenario, and a parking scenario respectively). In these implementations, vehicle 200 can perform driving scenario classifications (which in some implementations may be facilitated by artificial intelligence or machine learning) to determine driving scenarios 222, 224, and 226. Vehicle 200 may perform these classifications based on any number of operational parameters for vehicle 200 or parameters related to vehicle 200's contextual environment during a respective driving scenario. Examples of operational parameters that vehicle 200 may consider when determining/classifying driving scenarios can include—e.g., vehicle velocity (i.e., direction and speed of vehicle 200), vehicle acceleration, steering angle, throttle and brake operation, whether vehicle 200 is shifted into a drive gear vs. a reverse gear, etc. Examples of parameters related to vehicle 200's contextual environment that vehicle 200 may consider when determining/classifying driving scenarios can include e.g., a type of road segment that vehicle 200 is traversing (e.g., a multi-lane highway vs. a city road vs. a two-lane country road vs. a parking area), location of vehicle 200 within a road segment (e.g., what lane vehicle 200 is in, whether vehicle 200 is located at the side/shoulder of a road, etc.), vehicle 200's proximity to other objects and landmarks (e.g., other moving or parked vehicles, pedestrians, roadside infrastructure, traffic signs and signals, road markings indicating parking areas, etc.). As described in conjunction with FIG. 1, vehicle 200 may rely on various on-board sensors (e.g., image sensors and other proximity sensors, speed sensors, acceleration sensors, wheelspin sensors, throttle position and brake position sensors, gear position sensors, GPS/location sensors, etc.) and vehicle systems (e.g., mapping/navigation systems) to obtain information related to these operational and contextual environment parameters. In some cases, vehicle 200 may consider image data (e.g., image data 212, 214 and 216 respectively) obtained by such on-board sensors during a respective driving scenario when determining the respective driving scenario.

As another example, in some implementations driving scenarios 222, 224, and 226 may each comprise a score that quantifies a level of complexity for a driving scenario. Here, vehicle 200 may compute such a score based on the operational and contextual environment parameters described above.

In the specific example of FIGS. 2A-2C, driving scenario 222 may comprise a relative lowest complexity driving scenario among the three driving scenarios (i.e., among driving scenarios 222, 224, and 226). By contrast, driving scenario 226 may comprise a relative highest complexity driving scenario among the three driving scenarios. Thus, driving scenario 224 may comprise a middle complexity driving scenario among the three driving scenarios. For concept illustration, driving scenario 222 may comprise a highway driving scenario, driving scenario 224 may comprise a city driving scenario, and driving scenario 226 may comprise a parking scenario.

Referring now to neural network 250, neural network 250 may comprise various types of neural networks (e.g., a feedforward neural network, a neural network which relies on backpropagation, a recurrent neural network, a convolutional neural network, a residual neural network, etc.).

In the specific example of FIGS. 2A-2C, neural network 250 may comprise six neural layer units (i.e., neural layer units 251-256). It should be appreciated however that neural network 250 may comprise any number of neural layer units and that the depiction of neural network 250 in FIGS. 2A-2C is merely an illustrative example.

In certain implementations, each neural layer unit of neural network 250 may comprise a single neural layer. In other implementations, each neural layer unit of neural network 250 may comprise a block of neural layers. For example, in implementations where neural network 250 comprises a residual neural network (ResNet), neural layer unit 251 may comprise a first residual block comprising multiple neural layers, neural layer unit 252 may comprise a second residual block comprising multiple neural layers, etc.

In various implementations, neural layer unit 251 may comprise an input neural layer unit (e.g., an input neural layer or an input block) and neural layer unit 256 may comprise an output neural layer unit (e.g., an output neural layer or an output block). In such implementations, neural layer units 252-255 may comprise hidden neural layer units (e.g., hidden neural layers or hidden blocks).

While not depicted directly, in certain implementations neural network 250 may comprise skip connections which can be selectively activated or deactivated to skip/un-skip neural layer units. For example, a first skip connection may be activated to skip neural layer unit 252 when neural network 250 processes image data. By contrast, deactivating the first skip connection may ensure that neural layer unit 252 is not skipped (i.e., utilized) when neural network 250 processes image data. Similarly, a second skip connection may be activated to skip neural layer unit 253 when neural network 250 processes image data. By contrast, deactivating the second skip connection may ensure that neural layer unit 253 is not skipped (i.e., utilized) when neural network 250 processes image data. Likewise, a third skip connection may be activated to skip neural layer unit 254 when neural network 250 processes image data. By contrast, deactivating the third skip connection may ensure that neural layer unit 254 is not skipped (i.e., utilized) when neural network 250 processes image data. Similarly, a fourth skip connection may be activated to skip neural layer unit 255 when neural network 250 processes image data. By contrast, deactivating the fourth skip connection may ensure that neural layer unit 255 is not skipped (i.e., utilized) when neural network 250 processes image data.

As depicted, image data (e.g., image data 212, 214 and 216) may be provided to neural network 250. Neural network 250 may then process the image data, and in some implementations, output a representation of extracted image features (e.g., image features 262, 264 and 266 from FIGS. 2A, 2B, and 2C respectively).

As described above, by tailoring a number of skipped neural layers to different driving scenarios (e.g., driving scenarios 222, 224, and 226 from FIGS. 2A, 2B, and 2C respectively), vehicle 200 can increase computational power (i.e., by skipping a relatively fewer number of neural layer units) as complexity for the different driving scenarios increases. In this way, vehicle 200 may perform more accurately/reliably during relatively more complex driving scenarios (e.g., driving scenario 226 from FIG. 2C) than alternative solutions. Relatedly, vehicle 200 can decrease computational power (i.e., by skipping a relatively greater number of neural layer units, and thus skipping a greater number of matrix computations) as complexity for the different driving scenarios decreases. In this way, vehicle 200 may perform faster and consume less power during relatively less complex driving scenarios (e.g., driving scenario 222 from FIG. 2A) than alternative solutions.

For example (and as depicted in FIG. 2A), vehicle 200 may modify operation of neural network 250 to skip neural layer units 252, 253, 254, and 255 (i.e., four neural layer units) in response to determining vehicle 200 is operating in driving scenario 222. As described above, vehicle 200 can modify operation of neural network 250 to skip neural layer unit 252 by activating a first skip connection in neural network 250. Likewise, vehicle 200 can modify operation of neural network 250 to skip neural layer unit 253 by activating a second skip connection in neural network 250. Similarly, vehicle 200 can modify operation of neural network 250 to skip neural layer unit 254 by activating a third skip connection in neural network 250. Similarly, vehicle 200 can modify operation of neural network 250 to skip neural layer unit 255 by activating a fourth skip connection in neural network 250.

As depicted in FIG. 2B, vehicle 200 may modify operation of neural network 250 to only skip neural layer units 252 and 254 (i.e., two neural layer units) in response to determining vehicle 200 is operating in driving scenario 224. When transitioning from the state of FIG. 2A to the state of FIG. 2B, this may comprise: (1) deactivating the second skip connection to un-skip neural layer unit 253; and (2) deactivating the fourth skip connection to un-skip neural layer unit 255.

As depicted in FIG. 2C, vehicle 200 may modify operation of neural network 250 to not skip any neural layer units in response to determining vehicle 200 is operating in driving scenario 226. When transitioning from the state of FIG. 2B to the state of FIG. 2C, this may comprise: (1) deactivating the first skip connection to un-skip neural layer unit 252; and (2) deactivating the third skip connection to un-skip neural layer unit 254.

Accordingly, vehicle 200 can leverage a relatively highest amount of computational power (i.e., due to zero skipped neural layer units) when neural network 250 processes image data 216 obtained during the relative highest complexity driving scenario 226. Conversely, vehicle 200 can leverage a relative lowest amount of computational power (i.e., due to four skipped neural layer units) when neural network 250 processes image data 212 obtained during the relatively lowest complexity driving scenario 222. Similarly, vehicle 200 can leverage a relative middle amount of computational load (i.e., due to two skipped neural layer units) when neural network 250 processes image data 214 obtained during the relatively middle complexity driving scenario 224. As described above, vehicle 200 can reduce processing times and conserve power by skipping neural layer units in response to determining driving scenarios 224 and 226—which may not materially benefit from the relative highest amount of computational power used to process image data 216 for the relatively most complex driving scenario 226. Accordingly, in certain implementations vehicle 200 may use a larger neural network (e.g., a neural network comprising a relatively larger number of neural layers/neural layer units) than would be commercially practical in alternative solutions which cannot/do not scale down computational power for a neural network in response to determining relatively lower complexity driving scenarios.

In various implementations, modifying operation of neural network 250 to skip a determined number of neural layers based on driving scenario may comprise following a pre-determined rule (or pre-determined rules) which prescribe skipping arrangements or more generally a number of neural layer units to skip based on driving scenario. For example, a first pre-determined rule may prescribe skipping neural layer units 252, 253, 254, and 255 in response to determining driving scenario 222. A more general version of the first pre-determined rule may simply prescribe skipping four neural layer units, or four hidden neural layer units in response to determining driving scenario 222. A second pre-determined rule may prescribe skipping neural layer units 252 and 254 in response to determining driving scenario 224. A more general version of the second pre-determined rule may simply prescribe skipping two neural layer units, or two hidden neural layer units in response to determining driving scenario 224. A third pre-determined rule may prescribe not skipping any neural layer units in response to determining driving scenario 226.

In certain implementations where driving scenarios 222, 224, and 226 comprise numerical scores, vehicle 200 may use an algorithm or machine learning model to determine arrangement of skipped neural layer units (or more generally a number of skipped neural layer units) based on the computed numerical scores.

As described above, modifying operation of neural network 250 to skip (or un-skip) neural layer units may not modify, or otherwise depend on, values of trained weights of neural network 250. In other words, modifying operation of neural network 250 to skip (or un-skip) neural layer units may comprise maintaining trained weights of neural network 250 constant. Accordingly, the presently disclosed solution may consume less memory and processing resources than potential alternative solutions that—e.g., utilize multiple neural networks trained for different driving scenarios, or modify trained weights of a neural network based on driving scenario.

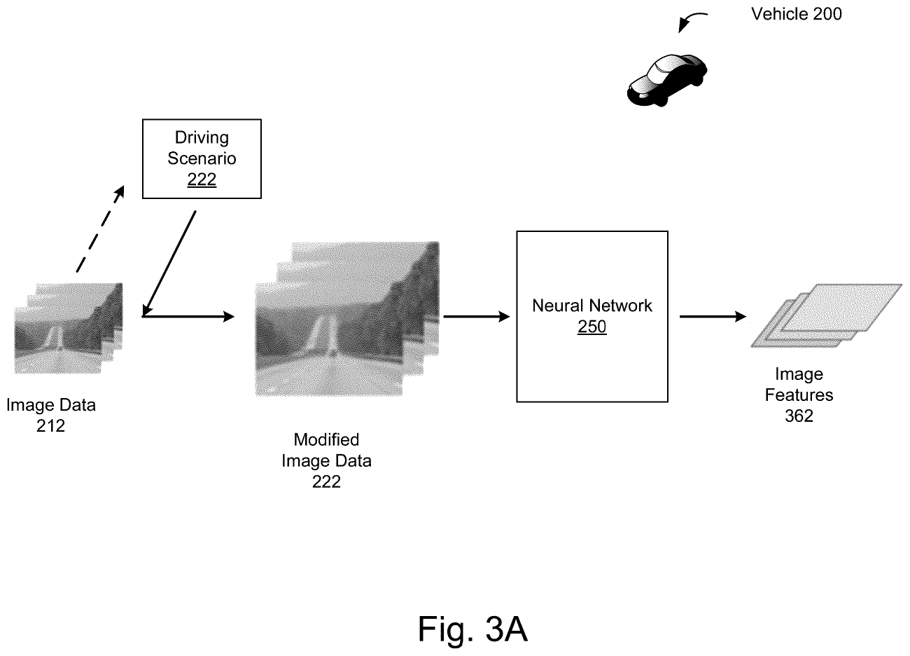

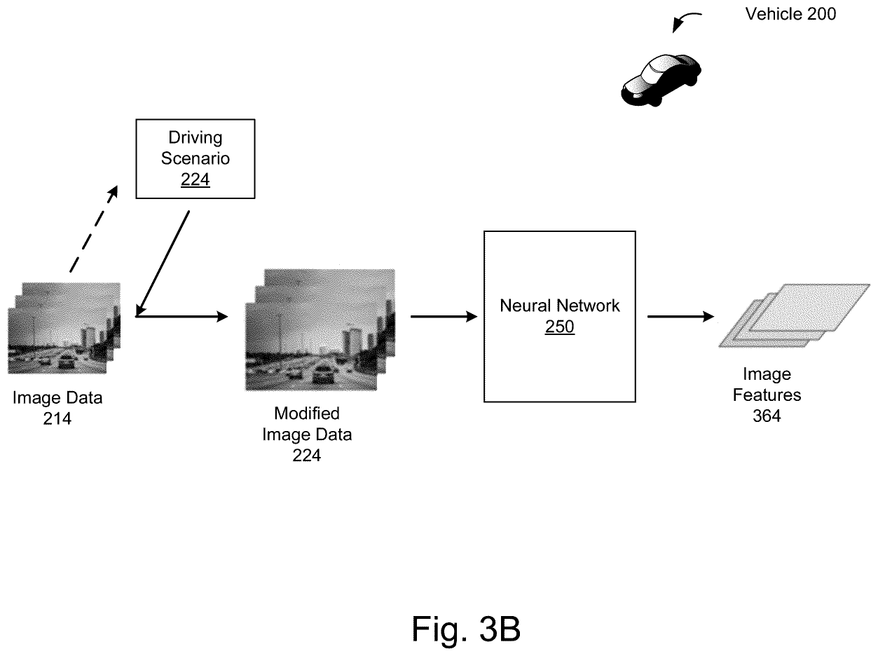

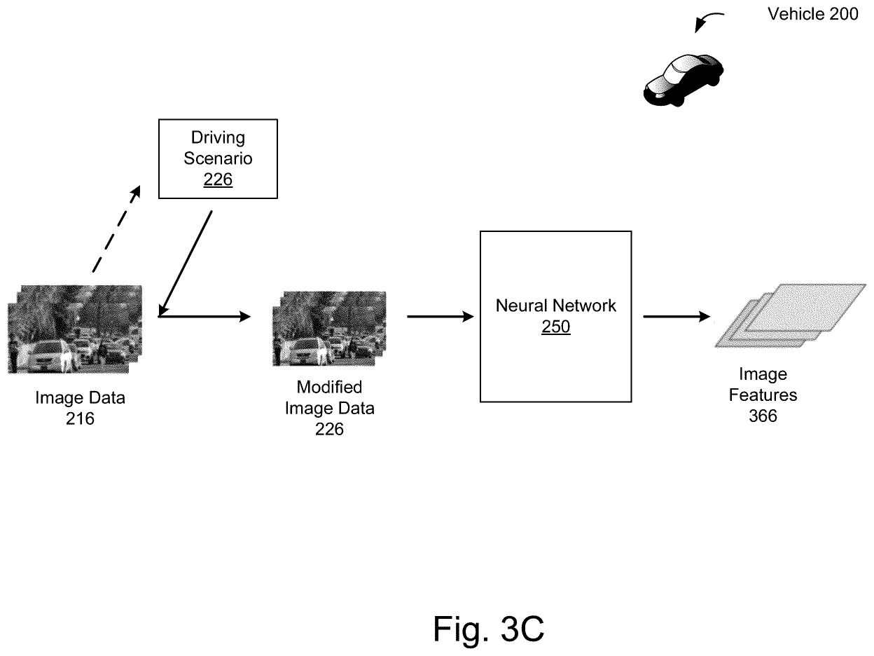

FIGS. 3A-3C illustrate an example process that can be performed by vehicle 200 (from FIGS. 2A-2C) to dynamically modify an input scale/input size for image data provided to neural network 250 (from FIGS. 2A-2C) based on driving scenario, in accordance with various embodiments of the presently disclosed technology.

As depicted, FIGS. 3A-3C include certain aspects/components in common with FIGS. 2A-2C described above. For example, in FIGS. 3A-3C vehicle 200 may utilize the same/similar neural network 250 as in FIGS. 2A-2C. Likewise, in FIGS. 3A-3C vehicle 200 may obtain the same/similar image data as in FIGS. 2A-2C (i.e., image data 212, 214, and 216 respectively).

As depicted in FIGS. 3A-3C (and as described above in conjunction with FIGS. 2A-2C), vehicle 200 can determine different driving scenarios that it is operating in. For example, in FIG. 3A vehicle 200 determines that it is operating in the (first) driving scenario 222 described in conjunction with FIG. 2A. Similarly, in FIG. 3B vehicle 200 determines that it is operating in the (second) driving scenario 224 described in conjunction with FIG. 2B. Likewise, in FIG. 3C vehicle 200 determines that it is operating in the (third) driving scenario 226 described in conjunction with FIG. 2C.

Vehicle 200 may utilize the same/similar techniques to make these driving scenario determinations as described in conjunction with FIGS. 2A-2C.

As described above, in some implementations driving scenario 222 may comprise a relative lowest complexity driving scenario among the three driving scenarios. By contrast, driving scenario 226 may comprise a relative highest complexity driving scenario among the three driving scenarios. Thus, driving scenario 224 may comprise a relative middle complexity driving scenario among the three driving scenarios.

In certain implementations (including the implementations described in the immediately preceding paragraph), driving scenario 222 may comprise a highway driving scenario, driving scenario 224 may comprise a city driving scenario, and driving scenario 226 may comprise a parking scenario. Here, the highway driving scenario (i.e., driving scenario 222) may exemplify a driving scenario which involves relatively largest spatial and temporal focuses among the three driving scenarios. By contrast, the parking scenario (i.e., driving scenario 226) may exemplify a driving scenario which involves relatively smallest spatial and temporal focuses among the three driving scenarios. Thus, the city driving scenario (i.e., driving scenario 224) may exemplify a driving scenario which involves relatively middle-sized spatial and temporal focuses.

As described above, by tailoring input scale for image data to different driving scenarios, vehicle 200 can leverage finer input scales (e.g., a relatively greater number of pixels per unit area, a relatively greater number of frames per unit time, etc.) as complexity for the different driving scenarios increases. In this way, vehicle 200 may perform more accurately/reliably during relatively more complex driving scenarios than alternative solutions. Relatedly, vehicle 200 can leverage coarser input scales (e.g., a relatively smaller number of pixels per unit area, a relatively smaller number of frames per unit time, etc.) as complexity for the different driving scenarios decreases. In this way, vehicle 200 may perform faster and consume less power during relatively less complex driving scenarios than alternative solutions.

For example (and as depicted in FIG. 3A), in response to determining driving scenario 222, vehicle 200 may modify image data 212 to a first input scale. Vehicle 200 may then provide the modified image data 222 to neural network 250 for processing (e.g., to extract image features 362). Here, modifying image data 212 to the first input scale may comprise modifying image data 212 to a first spatial input scale and a first temporal input scale. The first spatial input scale may comprise a first image resolution (e.g., a first number of pixels per unit area). The first temporal input scale may comprise a first frame rate (e.g., a first number of frames per unit time).

As depicted in FIG. 3B, in response to determining driving scenario 224, vehicle 200 may modify image data 214 to a second input scale. Vehicle 200 may then provide the modified image data 224 to neural network 250 for processing (e.g., to extract image features 364). Here, modifying image data 214 to the second input scale may comprise modifying image data 214 to a second spatial input scale and a second temporal input scale. The second spatial input scale may comprise a second image resolution (e.g., a second number of pixels per unit area). The second temporal input scale may comprise a second frame rate (e.g., a second number of frames per unit time). As described above, because driving scenario 222 (e.g., a highway driving scenario) is relatively less complex than driving scenario 224 (e.g., a city driving scenario), the first image resolution of the first input scale may comprise a lower image resolution (e.g., a fewer number of pixels per unit area) than the second image resolution of the second input scale. Similarly, the first frame rate of the first input scale may comprise a lower frame rate (e.g., a fewer number of frames per unit time) than the second frame rate of the second input scale.

As depicted in FIG. 3C, in response to determining driving scenario 226, vehicle 200 may modify image data 216 to a third input scale. Vehicle 200 may then provide the modified image data 226 to neural network 250 for processing (e.g., to extract image features 366). Here, modifying image data 216 to the third input scale may comprise modifying image data 216 to a third spatial input scale and a third temporal input scale. The third spatial input scale may comprise a third image resolution (e.g., a third number of pixels per unit area). The third temporal input scale may comprise a third frame rate (e.g., a third number of frames per unit time). As described above, because driving scenario 226 (e.g., a parking scenario) is relatively more complex than driving scenarios 222 and 224 (e.g., a highway driving scenario and a city driving scenario respectively), the third image resolution of the third input scale may comprise a higher image resolution (e.g., a greater number of pixels per unit area) than the first and second image resolutions of the first and second input scales respectively. Similarly, the third frame rate of the third input scale may comprise a higher frame rate (e.g., a greater number of frames per unit time) than the first and second frame rates of the first and second input scales respectively.

In certain implementations, vehicle 200 may also tailor input size based on driving scenario. For example, vehicle 200 can leverage relatively larger input sizes (e.g., relatively larger spatial regions of interest for image data, relatively larger time durations for image data) for driving scenarios which involve relatively larger spatial and temporal focuses (e.g., highway driving scenarios). By contrast, vehicle 200 can leverage relatively smaller input sizes (e.g., relatively smaller spatial regions of interest for image data, relatively shorter time durations for image data) for driving scenarios which involve relatively smaller spatial and temporal focuses (e.g., parking scenarios). By tailoring the input size of image data provided to neural network 250 based on driving scenario, vehicle 200 may perform more accurately/reliably and with greater efficiency than alternative solutions.

For example (and as depicted in FIG. 3A), in response to determining driving scenario 222, vehicle 200 may also modify image data 212 to a first input size. Vehicle 200 may then provide the modified image data 224 to neural network 250 for processing (e.g., to extract image features 362). Here, modifying image data 212 to the first input size may comprise modifying image data 212 to a first spatial input size and a first temporal input size. The first spatial input size may comprise a first spatial region of interest size (e.g., in cubic meters, cubic feet, etc.). The first temporal input size may comprise a first time duration (e.g., in seconds).

As depicted in FIG. 3B, in response to determining driving scenario 224, vehicle 200 may also modify image data 214 to a second input size. Vehicle 200 may then provide the modified image data 224 to neural network 250 for processing (e.g., to extract image features 364). Here, modifying image data 214 to the second input size may comprise modifying image data 214 to a second spatial input size and a second temporal input size. The second spatial input size may comprise a second spatial region of interest size (e.g., in cubic meters, cubic feet, etc.). The second temporal input size may comprise a second time duration (e.g., in seconds). As described above, because driving scenario 222 (e.g., a highway driving scenario) has a relatively larger spatial and temporal focus than driving scenario 224 (e.g., a city driving scenario), the first spatial region of interest size of the first input size may comprise a larger region (e.g., a greater number of cubic meters, a greater number of cubic feet, etc.) than the second spatial region of interest size of the second input size. Similarly, the first time duration of the first input size may comprise a longer time duration (e.g., a greater number of seconds) than the second time duration of the second input size.

As depicted in FIG. 3C, in response to determining driving scenario 226, vehicle 200 may also modify image data 216 to a third input size. Vehicle 200 may then provide the modified image data 226 to neural network 250 for processing (e.g., to extract image features 366). Here, modifying image data 216 to the third input size may comprise modifying image data 216 to a third spatial input size and a third temporal input size. The third spatial input size may comprise a third spatial region of interest size (e.g., in cubic meters, cubic feet, etc.). The third temporal input size may comprise a third time duration (e.g., in seconds). As described above, because driving scenario 226 (e.g., a parking scenario) has a relatively smaller spatial and temporal focus than driving scenarios 222 and 224 (e.g., a highway driving scenario and a city driving scenario respectively), the third spatial region of interest size of the third input size may comprise a smaller region (e.g., a smaller number of cubic meters, a smaller number of cubic feet, etc.) than the first and second spatial region of interest sizes of the first and second input sizes respectively. Similarly, the third time duration of the third input size may comprise a shorter time duration (e.g., a fewer number of seconds) than the first and second time durations of the first and second input sizes respectively.

In various implementations, modifying input scale/input size for image data provided to neural network 250 based on driving scenario may comprise following a pre-determined rule (or pre-determined rules) which prescribe a respective input scale/a respective input size for a respective driving scenario. For example, a first pre-determined rule may prescribe modifying image data to the first input scale and the first input size in response to determining driving scenario 222. A second pre-determined rule may prescribe modifying image data to the second input scale and the second input size in response to determining driving scenario 224. A third pre-determined rule may prescribe modifying image data to the third input scale and the third input size in response to determining driving scenario 226.

In certain implementations where driving scenarios 222, 224, and 226 comprise numerical scores, vehicle 200 may use an algorithm or machine learning model to determine input scale/input size for image data based on the computed scores.

As described above, providing image data with different input scales or input sizes may not modify, or otherwise depend on, values of trained weights of neural network 250. In other words, providing image data with different input scales or input sizes may comprise maintaining trained weights of neural network 250 constant. Accordingly, the presently disclosed solution may consume less memory and processing resources than potential alternative solutions that—e.g., utilize multiple neural networks trained for different driving scenarios, or modify trained weights of a neural network based on driving scenario.

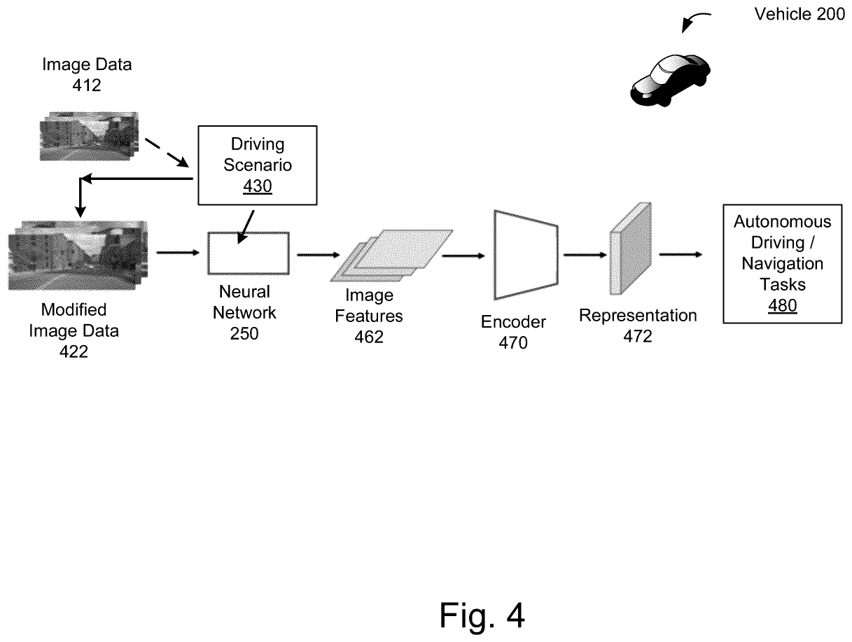

FIG. 4 illustrates an example process for processing image data 412 obtained by vehicle 200 (from FIGS. 2A-2C and 3A-3C), in accordance with various embodiments of the presently disclosed technology. In some implementations, vehicle 200 may perform the process.

For example, vehicle 200 may determine that it is operating in a driving scenario 430. Vehicle 200 may make this driving scenario determination in the same/similar manner as described in conjunction with FIGS. 2A-2C and 3A-3C.

As depicted, in response to determining driving scenario 430, vehicle 200 can modify operation of neural network 250 to skip a determined number of neural layers. Vehicle 200 can perform this step in the same/similar manner as described in conjunction with FIGS. 2A-2C.

As depicted, in response to determining driving scenario 430, vehicle 200 can modify input scale and input size for image data 412 to generate modified image data 422. Vehicle 200 can perform this step in the same/similar manner as described in conjunction with FIGS. 3A-3C.

As depicted, vehicle 200 can use neural network 250 (with the modified operation) to extract image features 462 from modified image data 422.

As depicted, vehicle 200 can utilize an encoder 470 to encode image features 462 into a refined representation 472 of vehicle 200's surrounding environment. In certain implementations, encoder 470 may comprise a machine learning model or neural network.

As depicted, vehicle 200 can then utilize refined representation 472 to perform autonomous driving or navigation tasks 480. Autonomous driving or navigation tasks 480 may comprise e.g., object detection tasks, map segmentation tasks, etc.

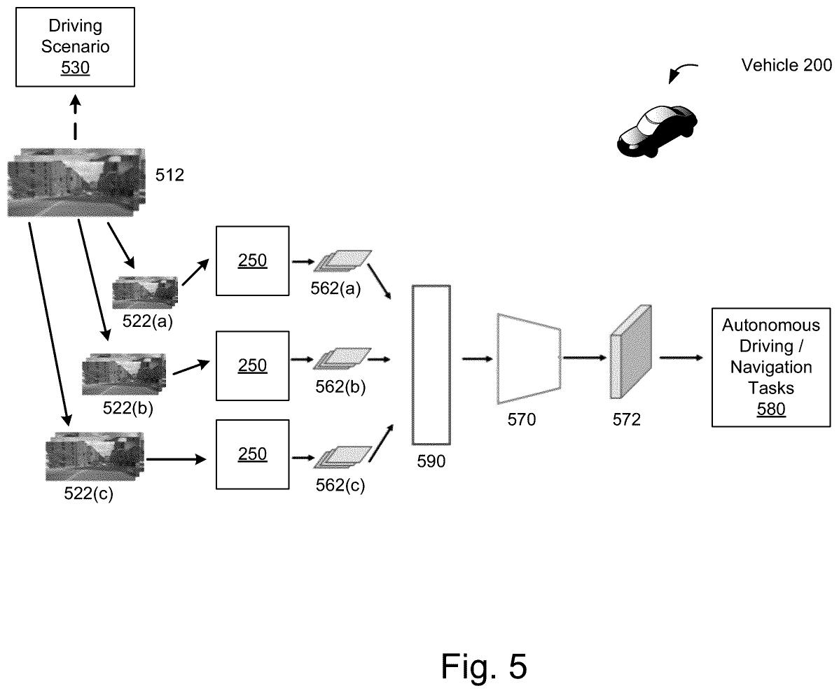

FIG. 5 illustrates an example process for processing image data 512 obtained by vehicle 200 (from FIGS. 2A-2C, 3A-3C and 4), in accordance with various embodiments of the presently disclosed technology. In some implementations, vehicle 200 may perform the process.

As described in greater detail below, FIG. 5 depicts a multi-scale fusion process where image data 512 is modified into multiple different input scales and multiple different input sizes. This modified image data—i.e., first modified image data 522 (a), second modified image data 522 (b), and third modified image data 522 (c)—may then be separately processed by neural network 250. Weighted outputs from such processing (weighted extracted image features) may then be combined into a multi-scale fusion representation 590. The multi-scale fusion representation 590 may then be encoded into a refined representation 572 of vehicle 200's environment—which may be leveraged for autonomous driving or navigation tasks 580. In certain cases, the multi-scale fusion representation 590 may be used to generate an improved version of refined representation 572. Namely, in certain cases multi-input scale/multi-input size processing of image data 512 may produce a more reliable/accurate result than single-input scale/single-input size processing. However, this may come at a cost of increased processing time, increased power consumption, etc.

Referring now to FIG. 5 in more detail, vehicle 200 may determine that it is operating in a driving scenario 530. Vehicle 200 may make this driving scenario determination in the same/similar manner as described in conjunction with FIGS. 2A-2C and 3A-3C.

As depicted, in response to determining driving scenario 530, vehicle 200 can modify input scale and input size for image data 512 to generate: (1) first modified image data 522 (a); (2) second modified image data 522 (b); and (3) third modified image data 522 (c). Vehicle 200 can perform this step in the same/similar manner as described in conjunction with FIGS. 3A-3C.

Here, first modified image data 522 (a) may comprise a first input scale and a first input size.

Second modified image data 522 (b) may comprise a second input scale and a second input size. In some implementations, the second input scale may be coarser than the first input scale. However, the second input size may also be larger than the first input size.

Third modified image data 522 (c) may comprise a third input scale and a third input size. In some implementations, the third input scale may be coarser than the first and second input scales. However, the third input size may also be larger than the first and second input sizes.

Accordingly, a range of input scales and input sizes may be represented by first modified image data 522 (a), second modified image data 522 (b), and third modified image data 522 (c).

As depicted, vehicle 200 can use neural network 250 to separately process first modified image data 522 (a), second modified image data 522 (b), and third modified image data 522 (c). For example, in certain implementations vehicle 200 can use a single instance of neural network 250 to process this modified image data sequentially. In other implementations, vehicle 200 can use three separate instances of neural network 250 to process the modified image data in parallel.

By either method, the processing of first modified image data 522 (a) may extract image features 562 (a). Similarly, the processing of second modified image data 522 (b) may extract image features 562 (b). Likewise, the processing of third modified image data 522 (c) may extract image features 562 (c).

As depicted, vehicle 200 can weight image features 562 (a)-(c) (e.g., according to a prescribed rule based on determining driving scenario 530) and fuse the weighted image features into a multi-scale fusion representation 590. Vehicle 200 can then use encoder 570 to encode multi-scale fusion representation 590 into a refined representation 572 of vehicle 200's environment during driving scenario 530. Vehicle 200 can then use refined representation 572 for autonomous driving or navigation tasks 580.

As described above, in certain cases multi-scale fusion representation 590 may be used to generate an improved version of refined representation 572. Namely, in certain cases multi-input scale/multi-input size processing of image data 512 may produce a more reliable/accurate result than single-input scale/single-input size processing. However, this may come at a cost of increased processing time, increased power consumption, etc.

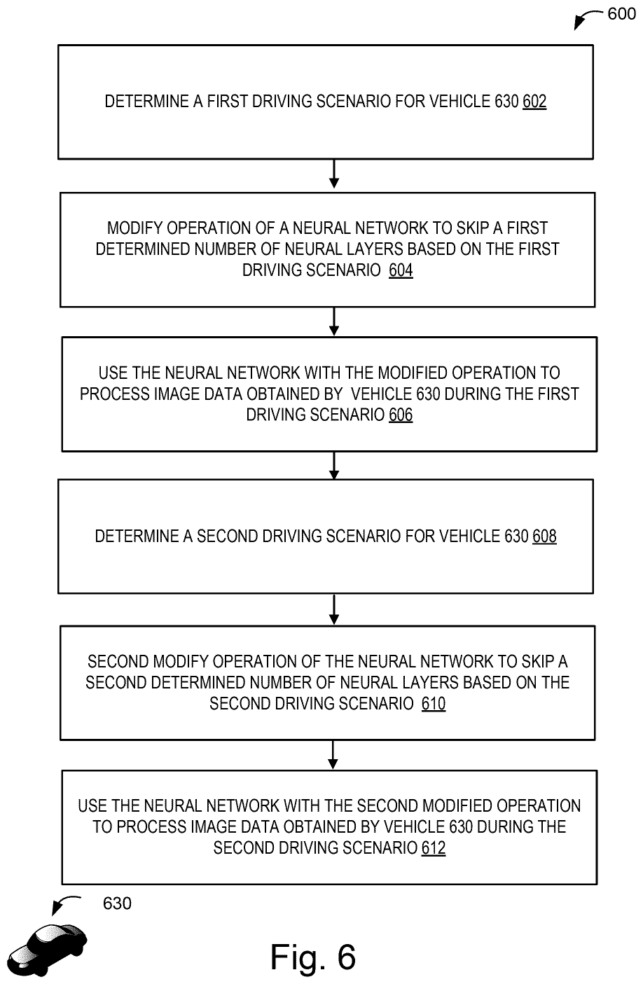

FIG. 6 illustrates an example process 600 that can be performed to tailor a number of skipped neural layers for a neural network based on driving scenario, in accordance with various embodiments of the presently disclosed technology. In some implementations, process 600 may be performed by a vehicle 630. In certain of such implementations, vehicle 630 may comprise the same/similar vehicle as vehicle 100 from FIG. 1.

As depicted, operation 602 may be performed to determine a first driving scenario for vehicle 630 (i.e., that vehicle 630 is operating in the first driving scenario). Various techniques may be used to determine the first driving scenario.

For example, in certain implementations the first driving scenario may comprise one of multiple pre-defined driving scenarios (e.g., a highway driving scenario, a city driving scenario, a parking scenario, etc.). In these implementations, determining first driving scenario may comprise performing a driving scenario classification (which in some implementations may be facilitated by artificial intelligence or machine learning). This driving scenario classification may be based on any number of operational parameters for vehicle 630 or parameters related to vehicle 630's contextual environment. Examples of operational parameters that may be considered when determining/classifying driving scenarios can include—e.g., vehicle velocity (i.e., direction and speed of vehicle 630), vehicle acceleration, steering angle, throttle and brake operation, whether vehicle 630 is shifted into a drive gear vs. a reverse gear, etc. Examples of parameters related to vehicle 630's contextual environment that may be considered when determining/classifying the first driving scenario can include e.g., a type of road segment that vehicle 630 is traversing (e.g., a multi-lane highway vs. a city road vs. a two-lane country road vs. a parking area), location of vehicle 630 within a road segment (e.g., what lane vehicle 630 is in, whether vehicle 630 is located at the side/shoulder of a road, etc.), vehicle 630's proximity to other objects and landmarks (e.g., other moving or parked vehicles, pedestrians, roadside infrastructure, traffic signs and signals, road markings indicating parking areas, etc.). As described in conjunction with FIG. 1, these operational and contextual environment parameters may be obtained from various on-board sensors of vehicle 630 (e.g., image sensors and other proximity sensors, speed sensors, acceleration sensors, wheelspin sensors, throttle position and brake position sensors, gear position sensors, GPS/location sensors, etc.) and vehicle systems of vehicle 630 (e.g., mapping/navigation systems).

As another example, in some implementations the first driving scenario may comprise a score that quantifies a level of complexity for a driving scenario. Here, such scores may be computed based on the operational and contextual environment parameters described above.

As depicted, operation 604 may be performed to modify operation of a neural network to skip a first determined number (e.g., zero or greater) of neural layers based on the first driving scenario.

As described above, in certain implementations modifying operation of the neural network to skip the first determined number of neural layers may comprise at least one of: (a) activating one or more skip connections in the neural network; or (b) deactivating one or more skip connections in the neural network.

In certain implementations, the first determined number of neural layers may comprise a first determined number of blocks of neural layers. For example, this may be the case when the neural network is a residual neural network comprising residual blocks which each comprise multiple neural layers.

In some implementations, modifying operation of the neural network to skip the first determined number of neural layers may comprise modifying operation of the neural network to have a first determined arrangement of skipped neural layers and un-skipped neural layers where the number of skipped neural layers in the first determined arrangement comprises the first determined number.

In various implementations, modifying operation of the neural network to skip the first determined number of neural layers may comprise following a pre-determined rule which prescribes skipping the first determined number of neural layers when vehicle 630 is operating in the first driving scenario.

As described above, modifying operation of the neural network to skip the first determined number of neural layers of the neural network may not modify, or otherwise depend on, values of trained weights of the neural network. In other words, modifying operation of the neural network to skip the first determined number of neural layers may comprise maintaining trained weights of the neural network constant (i.e., the same as before the first number of neural layers were skipped).

As depicted, operation 606 may be performed to use the neural network with the modified operation to process image data obtained by vehicle 630 during the first driving scenario.

Here, the image data may comprise, or otherwise be derived from, one or more images obtained by one or more image sensors (e.g., one or more cameras) of vehicle 630. In certain implementations, the image data may comprise a stream of images captured at different times during the first driving scenario. In various implementations, the image data may be obtained from multiple image sensors mounted on different locations of vehicle 630. Accordingly, the image data may capture vehicle 630's environment during the first driving scenario from multiple perspectives.

The neural network can be used to process the image data in various ways. For example, in implementations when the neural network is a backbone neural network, processing the image data may comprise extracting features from the image data. In other implementations, processing the image data may comprise encoding the image data into a representation (e.g., a numerical/matrix representation) of vehicle 630's environment during the first driving scenario.

As depicted, operation 608 may be performed to determine a second driving scenario for vehicle 630 (i.e., that vehicle 630 is operating in the second driving scenario). The same/similar techniques may be used to determine the second driving scenario as described above in conjunction with determining the first driving scenario.

As depicted, operation 610 may be performed to second modify operation of the neural network to skip a second determined number of neural layers based on the second driving scenario. The same/similar techniques may be used to skip the second determined number of neural layers based on the second driving scenario as described above in conjunction with skipping the first determined number of neural layers based on the first driving scenario.

As depicted, operation 612 may be performed to use the neural network with the second modified operation to process image data obtained by vehicle 630 during the second driving scenario. The same/similar techniques may be used to process the image data obtained during the second driving scenario as described above in conjunction with processing the image data obtained during the first driving scenario.

As described above, by tailoring a number of skipped neural layers to different driving scenarios (e.g., the first driving scenario and the second driving scenario), embodiments can increase computational power (i.e., by skipping a relatively fewer number of neural layers) as complexity for the different driving scenarios increases. In this way, embodiments may perform more accurately/reliably during relatively more complex driving scenarios than alternative solutions. Relatedly, embodiments can decrease computational power (i.e., by skipping a relatively greater number of neural layers, and thus skipping a greater number of matrix computations) as complexity for the different driving scenarios decreases. In this way, embodiments may perform faster and consume less power during relatively less complex driving scenarios than alternative solutions.

As an illustrative example, the first scenario driving may comprise a more complex driving scenario (e.g., a parking scenario) than the second driving scenario (e.g., a highway driving scenario). To account for this difference in complexity, the first determined number (e.g., zero or more) of skipped neural layers may comprise a smaller number than the second determined number (e.g., one or more) of skipped neural layers. Accordingly, embodiments may leverage greater computational power (i.e., a larger number of un-skipped neural layers) when processing the image data obtained during the first (more complex) driving scenario. By contrast, embodiments may perform faster and consume less power (i.e., due to the larger number of skipped neural layers—and correspondingly a larger number of skipped matrix computations) when processing the image data obtained during the second (less complex) driving scenario.

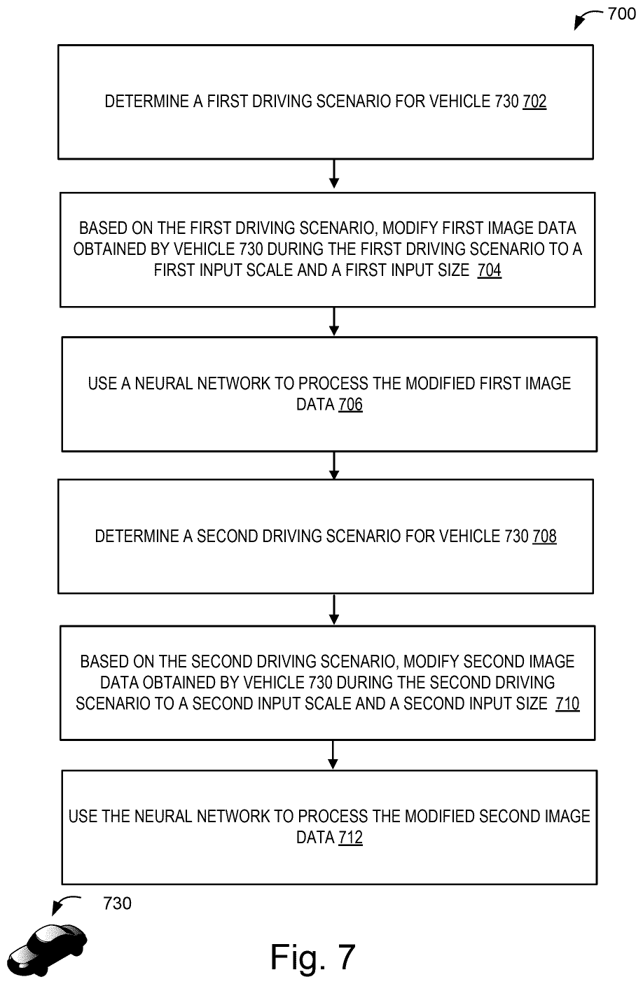

FIG. 7 illustrates an example process 700 that can be performed to dynamically modify input scale and input size for image data provided to a neural network based on driving scenario, in accordance with various embodiments of the presently disclosed technology. In some implementations, process 700 may be performed by a vehicle 730. In certain of such implementations, vehicle 730 may comprise the same/similar vehicle as vehicle 100 from FIG. 1.

As depicted, operation 702 may be performed to determine a first driving scenario for vehicle 730 (i.e., that vehicle 730 is operating in the first driving scenario). This operation may be performed in the same/similar manner as described above for operation 602 of FIG. 6.

Based on the first driving scenario, operation 704 may be performed to modify first image data obtained by vehicle 730 during the first driving scenario to a first input scale and a first input size.

Modifying the first image data to the first input scale may comprise at least one of: (1) modifying the first image data to a first spatial input scale; or (2) modifying the first image data to a first temporal input scale. Modifying the first image data to the first spatial input scale may comprise modifying the first image data to a first image resolution. Modifying the first image data to the first temporal input scale may comprise modifying the first image data to a first frame rate.

Modifying the first image data to the first input size may comprise at least one of: (1) modifying the first image data to a first spatial input size; or (2) modifying the first image data to a first temporal input size. Modifying the first image data to the first spatial input size may comprise modifying the first image data to a first spatial region of interest size. Modifying the first image data to the first temporal input size may comprise modifying the first image data to a first time duration.

As depicted, operation 706 may be performed to use a neural network to process the modified first image data (i.e., the first image data modified to the first input scale and the first input size). For example, processing the modified first image data may comprise extracting features of the modified first image data.

As depicted, operation 708 may be performed to determine a second driving scenario for vehicle 730 (i.e., that vehicle 730 is operating in the second driving scenario). This operation may be performed in the same/similar manner as described above for operation 608 of FIG. 6.

Based on the second driving scenario, operation 710 may be performed to modify second image data obtained by vehicle 730 during the second driving scenario to a second input scale and a second input size.

Modifying the second image data to the second input scale may comprise at least one of: (1) modifying the second image data to a second spatial input scale; or (2) modifying the second image data to a second temporal input scale. Modifying the second image data to the second spatial input scale may comprise modifying the second image data to a second image resolution. Modifying the second image data to the second temporal input scale may comprise modifying the second image data to a second frame rate.

Modifying the second image data to the second input size may comprise at least one of: (1) modifying the second image data to a second spatial input size; or (2) modifying the second image data to a second temporal input size. Modifying the second image data to the second spatial input size may comprise modifying the second image data to a second spatial region of interest size. Modifying the second image data to the second temporal input size may comprise modifying the second image data to a second time duration.

In certain implementations, the first driving scenario may comprise a more complex driving scenario (e.g., a parking scenario) than the second driving scenario (e.g., a highway driving scenario). Accordingly, in such implementations the first input scale may comprise a finer input scale than the second input scale (said differently, the second input scale may comprise a coarser input scale than the first input scale). For example, the first image resolution may comprise a higher resolution (i.e., a greater number of pixels per unit area) than the second image resolution. Likewise, the first frame rate may comprise a faster frame rate (i.e., a greater number of frames per unit time) than the second frame rate.

In some implementations the first driving scenario (e.g., a parking scenario) may involve a smaller spatial and temporal focus than the second driving scenario (e.g., a highway driving scenario). Accordingly, in such implementations the first input scale may comprise a smaller input scale than the second input scale. For example, the first spatial region of interest size may comprise a smaller region than the second spatial region of interest size. Likewise, the first time duration may comprise a smaller time duration than the second time duration.

As depicted, operation 712 may be performed to use the neural network to process the modified second image data (i.e., the second image data modified to the second input scale and the second input size).

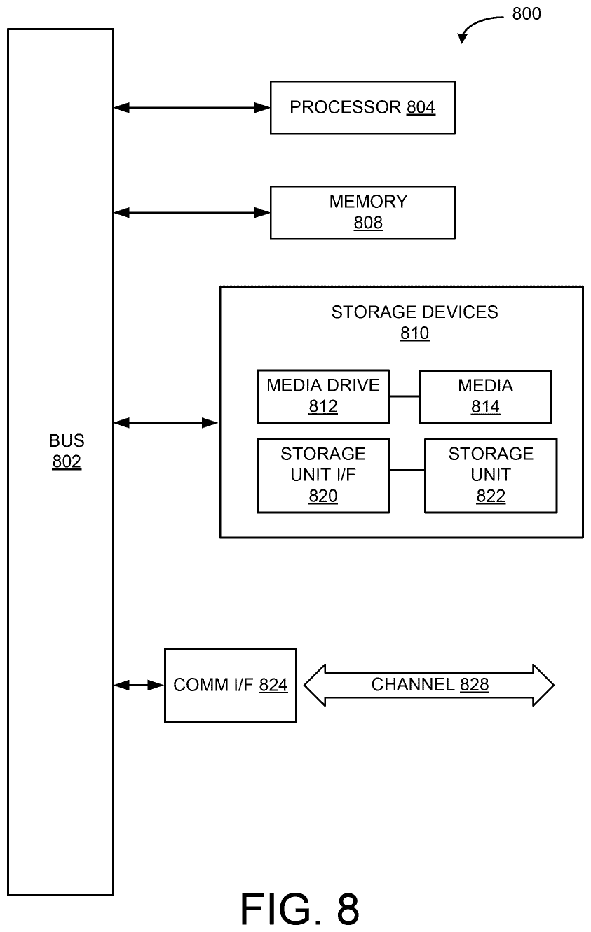

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 8. Various embodiments are described in terms of this example-computing component 800. After reading this description, it will become apparent to a person skilled in the relevant art how to implement the application using other computing components or architectures.

Referring now to FIG. 8, computing component 800 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 800 might also represent computing capabilities embedded within or otherwise available to a given device. For example, a computing component might be found in other electronic devices such as, for example, portable computing devices, and other electronic devices that might include some form of processing capability.

Computing component 800 might include, for example, one or more processors, controllers, control components, or other processing devices. This can include a processor, and/or any one or more of the components making up a user device, a user system, and a non-decrypting cloud service. Processor 804 might be implemented using a general-purpose or special-purpose processing engine such as, for example, a microprocessor, controller, or other control logic. Processor 804 may be connected to a bus 802. However, any communication medium can be used to facilitate interaction with other components of computing component 800 or to communicate externally.

Computing component 800 might also include one or more memory components, simply referred to herein as main memory 808. For example, random access memory (RAM) or other dynamic memory, might be used for storing information and instructions to be executed by processor 804. Main memory 808 might also be used for storing temporary variables or other intermediate information during execution of instructions to be executed by processor 804. Computing component 800 might likewise include a read only memory (“ROM”) or other static storage device coupled to bus 802 for storing static information and instructions for processor 804.

The computing component 800 might also include one or more various forms of information storage mechanism 810, which might include, for example, a media drive 812 and a storage unit interface 820. The media drive 812 might include a drive or other mechanism to support fixed or removable storage media 814. For example, a hard disk drive, a solid-state drive, a magnetic tape drive, an optical drive, a compact disc (CD) or digital video disc (DVD) drive (R or RW), or other removable or fixed media drive might be provided. Storage media 814 might include, for example, a hard disk, an integrated circuit assembly, magnetic tape, cartridge, optical disk, a CD or DVD. Storage media 814 may be any other fixed or removable medium that is read by, written to or accessed by media drive 812. As these examples illustrate, the storage media 814 can include a computer usable storage medium having stored therein computer software or data.

In alternative embodiments, information storage mechanism 810 might include other similar instrumentalities for allowing computer programs or other instructions or data to be loaded into computing component 800. Such instrumentalities might include, for example, a fixed or removable storage unit 822 and interface 820. Examples of such storage units 822 and interfaces 820 can include a program cartridge and cartridge interface, a removable memory (for example, a flash memory or other removable memory component) and memory slot. Other examples may include a PCMCIA slot and card, and other fixed or removable storage units 822 and interfaces 820 that allow software and data to be transferred from storage unit 822 to computing component 800.

Computing component 800 might also include a communications interface 824. Communications interface 824 might be used to allow software and data to be transferred between computing component 800 and external devices. Examples of communications interface 824 might include a modem or softmodem, a network interface (such as Ethernet, network interface card, IEEE 802.XX or another interface). Other examples include a communications port (such as for example, a USB port, IR port, RS232 port Bluetooth® interface, or other port), or other communications interfaces. Software/data transferred via communications interface 824 may be carried on signals, which can be electronic, electromagnetic (which includes optical) or other signals capable of being exchanged by a given communications interface 824. These signals might be provided to communications interface 824 via a channel 828. Channel 828 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 808, storage unit 820, media 814, and channel 828. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 800 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
determining a driving scenario for a vehicle;
modifying operation of a neural network to skip a determined number of neural layers based on the driving scenario; and
using the neural network with the modified operation to process image data obtained by the vehicle during the driving scenario.

2. The method of claim 1, wherein modifying operation of the neural network to skip the determined number of neural layers comprises at least one of:
activating one or more skip connections in the neural network; or
deactivating one or more skip connections in the neural network.

3. The method of claim 1, wherein modifying operation of the neural network to skip the determined number of neural layers comprises maintaining trained weights of the neural network constant.

4. The method of claim 1, further comprising:
determining a second driving scenario for the vehicle;
second modifying operation of the neural network to skip a second determined number of neural layers based on the second driving scenario; and
using the neural network with the second modified operation to process image data obtained by the vehicle during the second driving scenario;
wherein the determined number comprises a number of zero or greater, and the second determined number is greater than the determined number.

5. The method of claim 4, wherein:
the driving scenario is a parking scenario; and
the second driving scenario is a city driving scenario or a highway driving scenario.

6. The method of claim 4, wherein:
the driving scenario is a city driving scenario; and
the second driving scenario is a highway driving scenario.

7. A method comprising:
determining a driving scenario for a vehicle;
based on the driving scenario, modifying input scale for image data obtained by the vehicle during the driving scenario; and
using a neural network to process the modified image data.

8. The method of claim 7, wherein modifying the input scale for the image data comprises at least one of:
modifying spatial input scale for the image data based on the driving scenario; or
modifying temporal input scale for the image data based on the driving scenario.

9. The method of claim 8, wherein:
modifying the spatial input scale for the image data comprises modifying image resolution for the image data based on the driving scenario; and
modifying the temporal input scale for the image data comprises modifying frame rate for the image data based on the driving scenario.

10. The method of claim 8, further comprising:
determining a second driving scenario for the vehicle;
based on the second driving scenario, modifying input scale for second image data obtained by the vehicle during the second driving scenario; and
using the neural network to process the modified second image data.

11. The method of claim 10, wherein:
modifying the input scale for the image data comprises at least one of:
modifying the image data to a first image resolution based on the driving scenario, or
modifying the image data to a first frame rate based on the driving scenario; and
modifying the input scale for the second image data comprises at least one of:
modifying the second image data to a second image resolution based on the second driving scenario, or
modifying the second image data to a second frame rate based on the second driving scenario.

12. The method of claim 11, wherein:
the first image resolution comprises a greater number of pixels per unit area than the second image resolution; and
the first frame rate comprises a greater number of frames per unit time than the second frame rate.

13. The method of claim 12, wherein:
the driving scenario is a parking scenario; and
the second driving scenario is a city driving scenario or a highway driving scenario.

14. The method of claim 12, wherein:
the driving scenario is a city driving scenario; and
the second driving scenario is a highway driving scenario.

15. The method of claim 8, further comprising modifying input size for the image data based on the driving scenario, wherein the modified image data comprises the input scale modification and the input size modification.

16. The method of claim 15, wherein modifying the input size for the image data comprises at least one of:
modifying a spatial input size for the image data based on the driving scenario; or
modifying a temporal input size for the image data based on the driving scenario.

17. The method of claim 16, wherein:
modifying the spatial input size for the image data comprises modifying a spatial region of interest size for the image data based on the driving scenario; and
modifying the temporal input size for the image data comprises modifying a time duration for the image data based on the driving scenario.

18. A method comprising:
responsive to determining a first driving scenario for a vehicle:
modifying first image data obtained by the vehicle during the first driving scenario to a first input scale and a first input size, and
using a neural network to process the modified first image data; and
responsive to determining a second driving scenario for a vehicle:
modifying second image data obtained by the vehicle during the second driving scenario to a second input scale and a second input size, and
using a neural network to process the modified second image data;
wherein the first input scale comprises a finer input scale than the second input scale; and
wherein the first input size comprises a smaller input size than the second input size.

19. The method of claim 18, wherein:
modifying the first image data to the first input scale comprises at least one of:
modifying the first image data to a first image resolution, or
modifying the first image data to a first frame rate;
modifying the first image data to the first input size comprises at least one of:
modifying the first image data to a first spatial region of interest size, or
modifying the first image data to a first time duration;
modifying the second image data to the second input scale comprises at least one of:
modifying the second image data to a second image resolution, wherein the first image resolution comprises a greater number of pixels per unit area than the second image resolution, or
modifying the second image data to a second frame rate, wherein the first frame rate comprises a greater number of frames per unit area than the second frame rate; and
modifying the second image data to the second input size comprises at least one of:
modifying the second image data to a second spatial region of interest size, wherein the first spatial region of interest is smaller than the second spatial region of interest, or
modifying the second image data to a second time duration, wherein the first time duration is shorter than the second time duration.

20. A vehicle comprising:
one or more processing resources; and
non-transitory computer-readable medium, coupled to the one or more processing resources, comprising stored instructions that when executed by the one or more processing resources, cause the vehicle to:
responsive to determining a first driving scenario for the vehicle:
modify operation of a neural network to skip a first determined number of neural layers based on the first driving scenario,
modify first image data obtained by the vehicle during the first driving scenario to a first input scale, and
use the neural network with the modified operation to process the modified first image data; and
responsive to determining a second driving scenario for the vehicle:
second modify operation of the neural network to skip a second determined number of neural layers based on the second driving scenario, wherein the second determined number of neural layers is greater than the first determined number of neural layers,
modify second image data obtained by the vehicle during the second driving scenario to a second input scale, wherein the second input scale comprises a coarser input scale than the first input scale, and
use the neural network with the second modified operation to process the modified second image data.
